(19) United States
(12) Patent Application Publication
(10) Pub. No.: US 2016/0292518 A1
(43) Pub. Date: Oct. 6, 2016

(54) METHOD AND APPARATUS FOR MONITORING CHANGES IN ROAD SURFACE CONDITION

(71) Applicant: D-Vision C.V.S Ltd, Ramat Gan (IL)

(72) Inventors: Shmuel BANITT, Ramat Gan (IL); Yoav BANITT, Ramat Gan (IL)

(73) Assignee: D-Vision C.V.S Ltd, Ramat Gan (IL)

(21) Appl. No.: 15/083,457

(22) Filed: Mar. 29, 2016

Related U.S. Application Data
(60) Provisional application No. 62/177,954, filed on Mar. 30, 2015.
(60) Provisional application No. 62/177,956, filed on Mar. 30, 2015.

(51) Int. Cl. G06K 9/00; B60R 1/00; G06T 15/00; G06K 9/46; G06T 7/00; G06T 7/60; G06K 9/52; G06K 9/62; G06K 9/66

(52) U.S. Cl. CPC G06K 9/00805; G06K 9/6267; B60R 1/00; G06T 15/005; G06K 9/66; G06T 7/0042; G06T 7/60; G06K 9/52; G06K 9/4661; G06T 7/0075; G06K 9/6215; G06T 2207/30261; G06T 2200/04

(57) ABSTRACT

A method and system for detecting and classifying defects in a paved surface is disclosed. A sequence of images of the paved surface is obtained from at least one imaging device that can be mounted on a vehicle. The images are used to form a three-dimensional reconstruction. A machine learning process is used to train the system to recognize different kinds of defects and defect-free surfaces. Performing a pixel-by-pixel comparison of the images obtained for a particular paved surface with a database of images of surfaces with known defects provides a determination of the locations of defects in that paved surface. The system and method disclosed herein do not require the use of artificial lighting and are unaffected by transient changes in ambient light.

### REFERENCE TO RELATED PUBLICATIONS

This application claims priority from U.S. Provisional Pat. Appl. No. 62/177954, filed 30 Mar. 2015, and from U.S. Provisional Pat. Appl. No. 62/177956, filed 30 Mar. 2015. Both of these applications are incorporated by reference in their entirety.

### FIELD OF THE INVENTION

This invention relates in general to methods and means for monitoring changes in the condition of a paved surface. Specifically, it relates to methods that combine digital image acquisition and image processing to produce three-dimensional models.

### BACKGROUND OF THE INVENTION

Paved surfaces such as roads, runways, parking lots, and the like are inherently subject to heavy wear from traffic and degradation from weather conditions and ground movements. In order to maintain a safe and efficient network of roads, it is necessary to monitor the pavement condition regularly, plan maintenance programs, and repair the roads when necessary. In general, monitoring the condition of the surface is performed by surveying the roads by using imaging devices and/or lasers in order to find defects such as cracks and potholes. Analysis of images obtained in these surveys provides information about the type and severity of defects in the road surfaces, information that is essential for an efficient program of road maintenance and reconstruction.

At present, most public agencies responsible for road maintenance use a wholly subjective system in which skilled personnel inspect the paved surface or images of the paved surface to determine the presence and severity of pavement distress. These human evaluation procedures are very time consuming and labor intensive and are inherently inaccurate, unreliable and irreproducible. There is a growing effort worldwide to automate such procedures. Development of automated systems and methods for analyzing the paved surface or images thereof in order to detect the type and severity of surface defects remains a very challenging task.

One challenge that needs to be overcome in the development of an automated system for assessing the condition of a paved surface is to account for the changing, uncontrollable light conditions caused by sunlight and shade. Yet even in systems that attempt to overcome this difficulty by the use of artificial light, accurate and efficient detection and classification of all defects such as cracks and potholes remains difficult, because the colors (or gray levels) of the defects will vary from image to image depending on such factors as the type of imaging device used, the position of the imaging device relative to the defect, the position of the light source relative to the defect, the type of asphalt or concrete used, depth of the crack, whether a given crack is filled (by sand for example) or not, and so on. In order to be able to detect and classify any kind of surface damage under any inspection conditions, an automated detection system must be able take all of these factors into account. Such a system is not yet known in the art.

Several attempts have been made to develop an automatized process for detection and classification of defects in paved surfaces. Most of them describe devices that are designed to control light conditions and thereby reduce the level of complexity that is required in order to detect and classify any type of damage. These methods generally rely on the use of strong illumination, frequently including lasers. Lighting equipment that can provide the requisite level of illumination is expensive, heavy and complex, and requires the use of large power supplies and therefore frequently requires the use of specially designated vehicles to carry and operate it as well. A small number of devices that are designed to perform automatic detection and classification of defects in paved surfaces are known in the art, but these devices suffer from the opposite problem of being too simple to be used in practice.

Examples of such systems known in the art include the following.

A commercially available automated road and pavement condition data collection system is produced by Pathway Services Inc. This system uses four cameras, two of which are mounted on the front of a vehicle for providing a first set of images, and the remaining two of which are mounted on the back of the vehicle for providing a second set of images. In general, at least one of the two sets of images produced by this arrangement will be free of shadows caused by the vehicle carrying the cameras. Nonetheless, in many instances, both sets of images will include shadows coming from other sources such as trees or buildings at the side of the roadway. Moreover, this system is quite cumbersome, since it relies on the use of cameras mounted both at the front and at the back of the vehicle.

A road inspection system produced by Fugro-bre Inc. relies on the use of a digital camera and synchronized strobe lights for inspecting the road. This system is mounted on the rear of a vehicle and is quite cumbersome. Moreover, this system can only be used at night in order to avoid shadows and unpredictably varying daylight illumination conditions.

A system developed by Roadware for detecting cracks in a road surface uses matrix cameras with strobe lights to allow the system to operate in daytime. The cameras are capable of recording images at speeds up to 50 mph. One major disadvantage of this configuration is that the angle between the strobe lights and the cameras cause significant non-uniformities in the images, because pavement areas that are closer to the strobe lights appear much brighter than those further away, creating a lighting gradient that reduces the quality of the images.

A road inspection system produced by Waylink Corporation and the International Cybernetics Corporation comprises a single line-scan camera which has to be extended high above the vehicle on which the system is mounted. The system also comprises a large number of light bulbs in an attempt to produce a powerful uniform light line on the road to be inspected. The major disadvantage of this system is the large amount of electricity (several kW) needed to power the system, necessitating the use of a dedicated generator. The system is thus cumbersome, and moreover is unable to provide good shadow contrast in the images, especially in the case of longitudinal cracks.

None of the above mentioned inspection systems provides a compact and power-efficient assembly that can perform a rapid and accurate road surface inspection that is unaffected by changes in local light conditions.

Researchers at the University of Texas have developed a system that attempts to detect cracks in a road surface automatically based on images from an imaging device. This method assumes that cracks are made of a dark “seed” that can be identified in an image as being darker above a certain threshold than the neighboring pixels in the image. The method then assumes that the rest of the crack can be detected based on its similarity to the seed and its contrast to the surrounding non-cracked surface. This method only provides detection of four types of cracks. Furthermore, it can only identify the cracks if they are darker than the surrounding surface, which is often not the case. Furthermore, the method does not specify the threshold that is used to mark crack seeds or cracks, and indeed, the threshold is different for every image and every crack. This method suffers not only from these limitations, but also requires the use of artificial lighting, adding expense and complexity to the system.

While the foregoing challenges in the development of methods and systems for automatic detection and classification of defects in paved surface have been recognized for many years, none of the proposed solutions known in the art has succeeded in producing a single device that can adequately addressing all of them. Thus, a method and system for detection and classification of defects in paved surfaces that can provide early detection of relatively small cracks in paved surfaces at early stages of their formation, that reduces overlap and reliance on human judgment, that produces high-resolution images while allowing monitoring at highway speeds, and that is cost- and energy-efficient, remains a long-felt, but as yet unmet need.

### SUMMARY OF THE INVENTION

The invention disclosed herein is designed to meet this long-felt need. It uses methods of machine learning to train a system to detect defects of all shapes, forms, and colors or gray levels. It only requires an off-the-shelf digital camera and an image processing and storage device (e.g. a properly programmed laptop computer), but is nonetheless fully automatic, compact, energy efficient, and does not need any kind of correction or compensation for ambient light conditions.

It is thus an object of the present invention to disclose a system for detecting and classifying defects in a paved surface, comprising: (a) at least one imaging device configured to be mountable on a vehicle and to obtain a sequence of images of a paved surface; and, (b) a processing and storage device in data communication with said at least one imaging device, said processing and storage device configured to store images obtained by said at least one imaging device and to perform three-dimensional reconstructions of overlapping portions of images obtained by said imaging device. In some preferred embodiments of the invention, said system comprises exactly one imaging device (1), and said processing and storage device is configured to perform three-dimensional reconstructions of overlapping portions of successive images in said sequence of images. In some other preferred embodiments of the invention, said system comprises two imaging devices (1, 2) positioned such that fields of view of said imaging devices at least partially overlap, and said processing and storage device is configured to perform three-dimensional reconstructions from overlapping areas in images taken simultaneously by said two imaging devices.

It is a further object of the present invention to disclose a system as defined in any of the above, comprising a laser range finder.

It is a further object of the present invention to disclose a system as defined in any of the above, comprising a geolocation device in data communication with said at least imaging device via said storage and processing device.

It is a further object of the present invention to disclose a system as defined in any of the above, wherein said processing and storage device is programmed to incorporate a training process that utilizes machine learning techniques to build a database of descriptors relating to distinct features of surface conditions.

It is a further object of the present invention to disclose a system as defined in any of the above, wherein each of said at least one imaging device is configured to obtain images of an area of at least 4 m×4 m at a resolution of 1 mm² per pixel.

It is a further object of the present invention to disclose a system as defined in any of the above, wherein said at least one imaging device is mounted at the rear of a vehicle. In some preferred embodiments of the invention in which it is mounted at the rear of a vehicle, said imaging device is characterized by an image acquisition rate sufficient to provide at least 75% overlap between successive images in said image sequence.

It is a further object of the present invention to disclose a method for detecting and classifying defects in a paved surface, comprising: (a) obtaining a system as defined in any of the above; (b) performing a training process to build a database of descriptors of distinct features of surface conditions in images from a set of images (22) of paved surfaces with known surface conditions; (c) obtaining a sequence of images (20) of a paved surface; (d) if said system comprises exactly one imaging device, performing a three-dimensional reconstruction of overlapping areas of successive images in said sequence of images; (e) if said system comprises exactly two imaging devices with overlapping fields of view: obtaining said sequence of images by obtaining a sequence of images simultaneously from each of said two imaging devices; and performing a three-dimensional reconstruction of overlapping areas of images obtained simultaneously by said two imaging devices; and, (f) performing a detection process, comprising: (i) calculating paved surface descriptors of said paved surface for each image in said sequence of images; (ii) comparing said paved surface descriptors to said database of descriptors obtained from said training process; (iii) if, in a particular image from said sequence of images, said paved surface descriptors are similar to descriptors from said database of descriptors associated with a specific defect, marking said particular image as indicating said specific defect in said paved surface; (iv) if, in a particular image from said sequence of images, said paved surface descriptors are similar to descriptors from said database of descriptors associated with a defect-free surface, marking said particular image as indicating said paved surface is free of defects.

It is a further object of this invention to disclose such a method, in which said system comprises a laser range finder and said method comprises using said laser range finder to map a three-dimensional position of a location corresponding to each pixel in the image relative to said imaging device.

It is a further object of this invention to disclose such a method as defined in any of the above, in which said system comprises a geolocation device and said method comprises: determining relative positions of said at least one imaging device and said geolocation device; determining relative positions of said imaging device and a position corresponding to each pixel on said surface within said imaging device's field of view; determining coordinates of an absolute location of said geolocation device when each image in said sequence of images is obtained; and, calculating coordinates of an absolute location of paved surface corresponding to each pixel in said image.

It is a further object of this invention to disclose such a method as defined in any of the above, wherein said step of calculating paved surface descriptors comprises calculating paved surface descriptors by using a contrast method comprising: determining a gray level for each pixel P in said image; and calculating a contrast value for each pixel P in said image as a sum of absolute differences between said gray level of said pixel P and an average gray level of a predetermined subset of other pixels in said image. In some preferred embodiments of the invention, said predetermined subset comprises the eight nearest neighbor pixels surrounding pixel P. In some preferred embodiments of the invention, said contrast method comprises calculating a plurality of contrast values for each pixel P by using a plurality of different predetermined subsets.

It is a further object of this invention to disclose such a method as defined in any of the above, wherein said step of calculating paved surface descriptors comprises calculating paved surface descriptors by using a 3D construction method comprising: calculating a set of three-dimensional coordinates for each pixel P in said image, thereby creating a voxel V for each pixel P; determining the depth of each voxel V relative to said imaging device; and, calculating a depth value for each voxel V in said image as a sum of absolute differences between said depth of said voxel V and an average depth of a predetermined subset of other voxels in said image. In some preferred embodiments of the method, said 3D construction method comprises calculating a plurality of contrast values for each voxel V by using different predetermined subsets.

It is a further object of this invention to disclose such a method as defined in any of the above, wherein said step of comparing said paved surface descriptors to said database of descriptors obtained from said training process comprises comparing said paved surface descriptors to said database of descriptors obtained from said training process by using a Nearest Neighbor method.

It is a further object of this invention to disclose such a method as defined in any of the above, wherein said step of comparing said paved surface descriptors to said database of descriptors obtained from said training process comprises comparing said paved surface descriptors to said database of descriptors obtained from said training process by using a Support Vector Machine method.

It is a further object of this invention to disclose such a method as defined in any of the above, wherein said step of comparing said paved surface descriptors to said database of descriptors obtained from said training process comprises comparing said paved surface descriptors to said database of descriptors obtained from said training process by using a Artificial Neural Network method.

### BRIEF DESCRIPTION OF THE DRAWINGS

The invention will now be described with reference to the drawings, wherein:

FIGS. 1A, 1B, and 1C present schematic representations of three embodiments of a system for detecting pavement damage according to the present invention;

FIG. 2 presents an example of an image produced by the system of the present invention of a portion of a road surface;

FIG. 3 presents a second example of an image produced by the system of the present invention of a road surface in which the road surface has different types of defects than the road surface imaged in FIG. 2;

FIG. 4 presents a schematic diagram of the processing device of the present invention;

FIG. 5 presents a schematic diagram of the training process used in the method of the present invention;

FIG. 6 presents a schematic diagram of the detection and classification process used in the method of the present invention;

FIG. 7 presents the results of a contrast descriptor method of the present invention as applied to the image shown in FIG. 3; and,

FIG. 8 presents the results of a 3D reconstruction descriptor method as applied to the image shown in FIG. 3.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest interpretation of said claims.

As used herein, the term “paved surface” refers to any surface covered with at least one layer of a solid paving material. Non-limiting examples of “paved surfaces” within the meaning of the term as used herein include paved roadways, bridge surfaces, parking lots, and airplane runways. Non-limiting examples of paving materials with which the surface may be covered include concrete and asphalt.

As used herein, the term “imaging device” refers to any device that can obtain an image (a representation of an object or scene). Non-limiting examples of imaging devices within the scope of this definition include cameras (film or digital), video cameras, and ultrasound imaging systems.

As used herein, with reference to numerical quantities, the term “about” refers to a tolerance of ±20% relative to the nominal quantity.

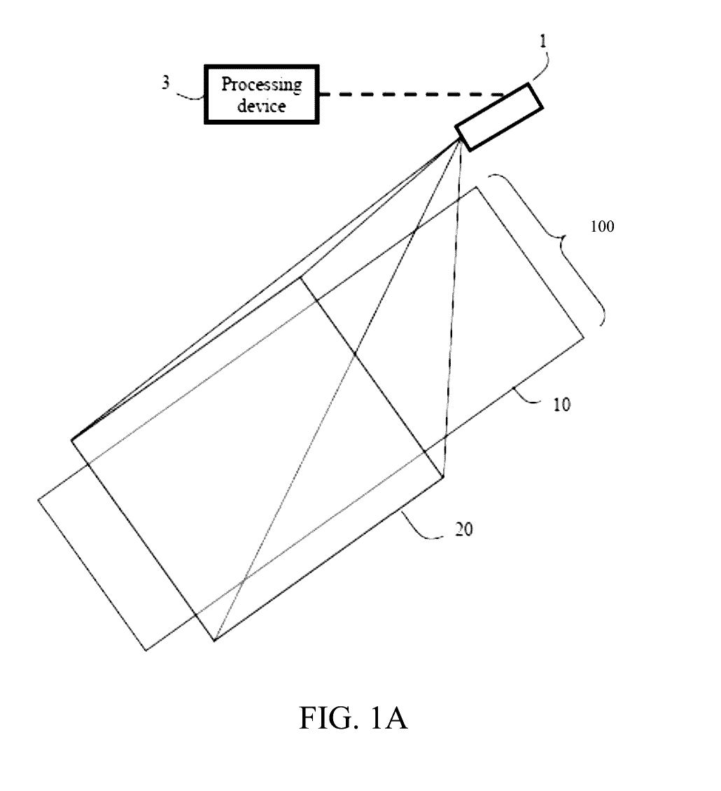

Reference is now made to FIG. 1A, which depicts schematically one preferred embodiment of the present invention. An imaging device 1 is mounted on a vehicle and is connected via a standard data connection to image storage and processing device 3. In preferred embodiments of the invention, the imaging device is a high-resolution digital camera. The imaging device is directed at paved surface 10 such that a sequence of images 20 can be produced. Each image captures a width 100 of the paved surface; in typical embodiments, the width of coverage of each image is about 4 m. In preferred embodiments in which a road surface is being imaged, the width is sufficient such that each image captures an entire lane. In preferred embodiments, the imaging device is configured such that consecutive images in the sequence overlap, thereby enabling reconstruction of the surface. In some preferred embodiments, imaging device 1 is positioned on the rear of the vehicle. In some preferred embodiments, the imaging device is configured to capture an image covering an area of 4 m by 4 m.

One embodiment of the method disclosed herein uses the system depicted in FIG. 1. A sequence of images is taken by the imaging device configured as described above. In preferred embodiments of the invention, each successive image in the sequence is taken after the vehicle has advanced 1 meter. Each successive image thus has a 75% overlap with the previous one (12 m² out of 16 m²). A three-dimensional reconstruction of the overlapping portion of successive images is then produced from the sequence of images by using standard Structure from Motion techniques known in the art. A non-limiting example of such a technique is disclosed in Dellaert, F.; Seitz, S.; Thorpe, C.; and Thrun, S., “Structure from Motion without Correspondence,” IEEE Computer Society Conference on Computer Vision and Pattern Recognition, which is hereby incorporated by reference in its entirety. In preferred embodiments of the invention, the frame rate of the imaging device is high enough to provide the necessary overlap at highway driving speeds. As a non-limiting example, if the vehicle is traveling at 100 km/h (27.7 m/s), a frame rate of 27.7 frames per second will be necessary to ensure that there is a 75% overlap if an image is captured every meter. The actual amount of overlap required may change depending on the condition of the paved surface. If a higher overlap between successive frames is desired, then the necessary frame rate of the imaging device will have to be adjusted accordingly. As a second non-limiting example, if consecutive 4 m×4 m frames are taken after the vehicle has moved 30 cm, providing a 92.5% overlap, the frame rate of the imaging device will be about 90 frames per second.

Damage to the road surface can then be estimated, as described in detail below.

Reference is now made to FIG. 1B, which depicts schematically a second preferred embodiment of the present invention in which a plurality of imaging devices is used. In the embodiment illustrated in the figure, two imaging devices 1 and 2 are mounted on a vehicle and connected to image processing and storage device 3. Each imaging device captures part of the desired total imaging width 100 (e.g. a lane of a roadway) such that the entire desired imaging width is captured. As with the embodiment illustrated in FIG. 1A, in typical embodiments, the total imaging width of the system depicted in FIG. 1B is about 4 m. In the specific embodiment illustrated, the two imaging devices 1 and 2 are mounted at the rear of the vehicle in known positions (relative or absolute) such that the fields of view of the two imaging devices overlap.

In the method disclosed herein in which the embodiment of the apparatus depicted in FIG. 1B is used, a sequence of images are taken by the plurality of imaging devices in which the fields of view overlap, as described above. In this embodiment, images are acquired simultaneously by the plurality of imaging devices, and a three-dimensional reconstruction of the overlapping area is then produced by using photogrammetry and stereoscopic methods known in the art. A non-limiting example of such a method is disclosed in Julesz, B., “Binocular Depth Perception of Computer-Generated Images,” Bell Syst. Tech. J. 39, 1125-1163 (1960), which is hereby incorporated by reference in its entirety.

Damage to the paved surface can then be determined, as described in detail below.

Reference is now made to FIG. 1C, which presents a schematic illustration of a third preferred embodiment of the invention herein disclosed. In this embodiment, the at least one imaging device 1 is connected via image storage and processing device 3 to a geolocation device 4 such as a GPS device configured to determine and/or record an object's location and placed at a known distance from the imaging device. In preferred embodiments of the invention, the imaging device and position determining device are mounted on a vehicle, e.g. at the rear of the vehicle. The geolocation device is configured to record its absolute location and hence that of the vehicle and the imaging device from the known distances between the geolocation device's antenna and the vehicle and imaging device. In some embodiments, the system comprises a laser range finder (not shown in the figure) that is configured to map the position of every pixel in an image relative to the location of the imaging device.

In embodiments of the method herein disclosed in which the embodiment of the system shown in FIG. 1C is used, the imaging device is calibrated such that every pixel is mapped onto a surface at a distance of paved surface 10 from the imaging device. For example, a checkerboard pattern can be placed on the paved surface. The length of the sides and area of each square on the checkerboard pattern are determined. Assuming that the road surface is essentially planar, a homography is calculated for converting every pixel in image 20 to a three-dimensional location relative to the position of the imaging device. Additionally or alternatively, the pavement area under the imaging device is measured and mapped to calibrate the position of the location corresponding to each pixel in the image relative to the position of the imaging device. In embodiments in which the system includes a laser range finder, the laser range finder is used to map the three-dimensional position of the location corresponding to each pixel in the image relative to the imaging device.

The absolute location of the antenna of the geolocation device 4 is determined (e.g. by standard GPS location methods); since the geolocation device and the imaging device are synchronized via processing device 3, the location of the antenna can be determined at the time that each image is obtained. The location of the imaging device or devices at the time that each image is obtained is calculated from the known relative locations of the geolocation device and the imaging device. The homography is then used to assign an absolute position to each pixel in each image. Each pixel in the image that corresponds to damage 30 (damage can be determined by the method described in detail below) is likewise assigned an absolute location (e.g. GPS coordinates).

In the method disclosed herein, the next time that the same section of paved surface is surveyed, the two images corresponding to the same area of the paved surface (as determined either empirically or from the calculated absolute coordinates) are compared and any damage detected is matched to damage detected in previous surveys by matching the images and standard image processing comparison methods. After the damages are matched, differences between them are determined. For example, if damage 30 is a crack in the paved surface, it may have gotten wider or longer during the time between the two surveys. Resolution of the rate of change in the paved surface depends on the image resolution. For example, if each pixel corresponds to 1 mm² of surface (i.e. a 4000 pixel by 4000 pixel image for a 16 m² square area), the rate of change of the observed damage will be reported at a resolution of mm² per unit time. The change of the dimensions of the surface damage divided by the time interval between the two surveys will provide an estimate of the rate of change in, and the projected residual lifetime of, the paved surface. Additional surveys will improve the accuracy and time resolution of these estimates.

In another preferred embodiment of the method, the rate of change in the paved surface is tested for correlations with environmental factors such as temperature changes, rainfall, traffic load, ground type, etc. These correlations can be used to further improve the estimate of the residual lifetime of the paved surface.

In preferred embodiments of the method, all of the information obtained from the imaging devices is stored in a database. This database can be used to plan new roads, based on the environmental conditions of the region and the expected traffic load.

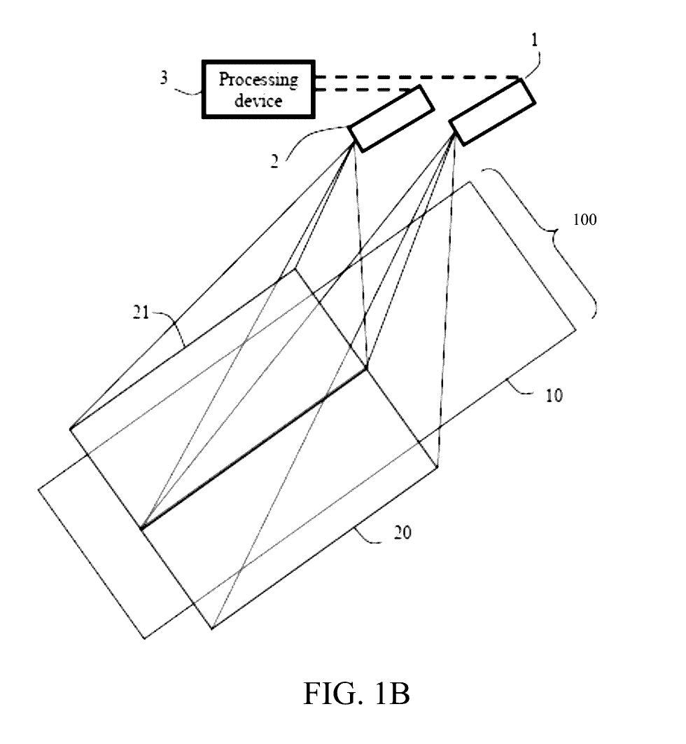

Reference is now made to FIG. 2, which shows an image that was captured using the apparatus of the present invention. The image shows examples of surface damage with very different characteristics. Some of the damaged areas are darker than the paved surface, some are brighter, and some have both dark and bright areas. Some of the dark areas appearing in the image are shadows, while most of the bright areas are due to dirt or reflections of the sun on the paved surface. Image processing methods known in the art that are designed to detect dark areas in the image will not detect all of the surface damage appearing in the image, nor will laser-based methods that detect surface damage as areas that are deeper than the surface, since some of the cracks are filled with sand to the level of the paved surface.

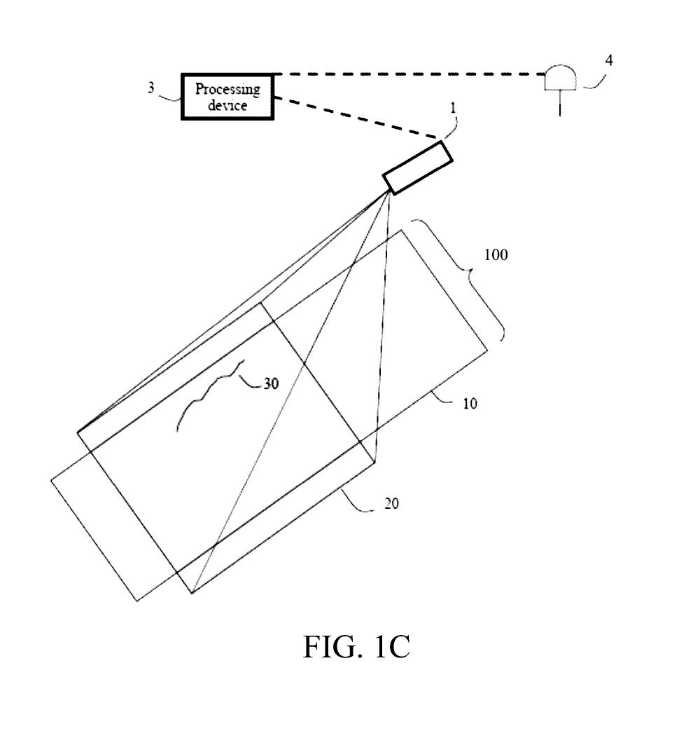

Reference is now made to FIG. 3, which presents a second example of a damaged paved surface in which the damage manifests itself as a combination of brighter and darker areas on a background of varying brightness in which some of the dark regions are shadows. In the example shown in FIG. 3, some of the dark areas are oil spots that should not be classified as damage, as methods known in the art that detect dark areas in the image are likely to do.

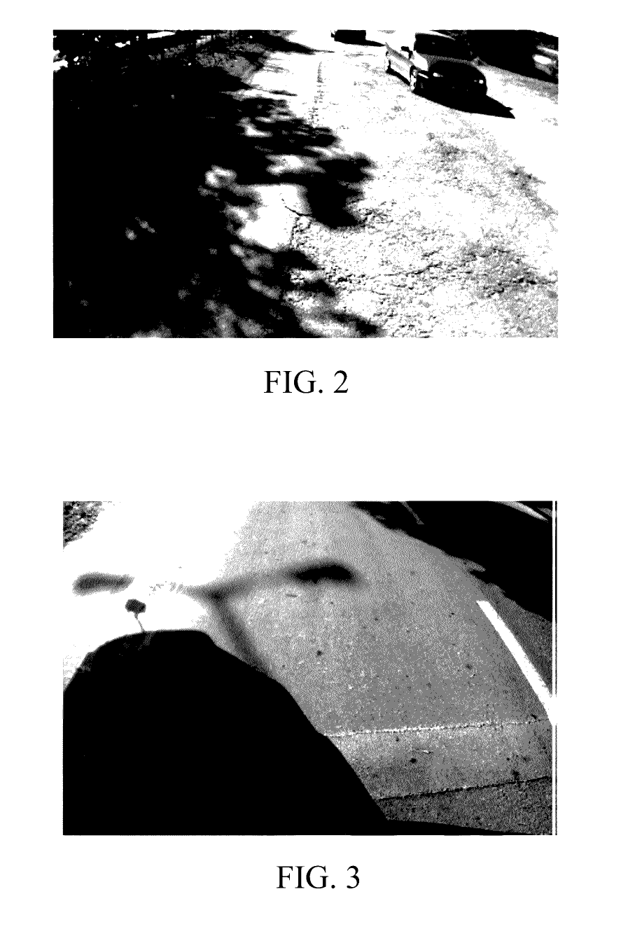

Reference is now made to FIG. 4, which illustrates schematically the main steps of the method herein disclosed. In the inventive method, the images obtained by the imaging device are collected and stored by image processing device 3. The image processing device is configured to have machine learning capabilities and can be trained to identify defects or other objects of interest in the images of paved surface 20. A set of descriptive methods 35 is applied to a set of images 22 to produce a set of descriptors of surface conditions 31. When a new image 20 is examined to determine the condition of the surface in the image, the set of descriptors 35 is applied to the image to produce a set of descriptors for the new image 32. The set of descriptors of the new image 32 is then compared to the set of descriptors of set of trained images 31, and a decision is made about the condition of the surface appearing in the new image 50.

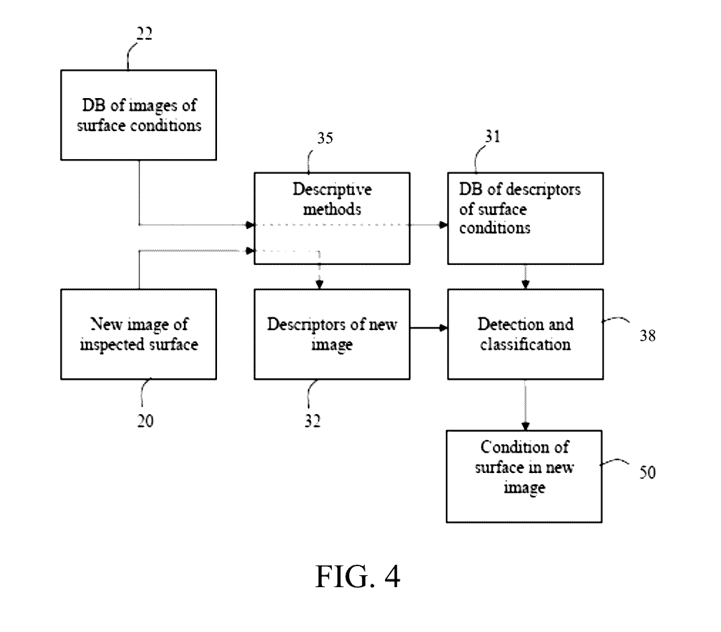

Reference is now made to FIG. 5, which illustrates schematically the training process of the method herein disclosed, i.e. the machine learning procedures used to train the processing device to recognize and detect defects in the surface 20 from the images in the database created as described above. The training is performed by building a database of distinct features of surface conditions 31 in the images. The distinct features are obtained by applying descriptive methods 35 that provide an account of the environment around every pixel in the image. In the training stage, the methods 35 are applied to images with known surface conditions 22. The result of the descriptive methods is a set of distinct features called “descriptors” 32 that are typical to the surface conditions. In order to be able to classify a portion of a surface as intact, the images of surface conditions include images of intact surfaces as well as images of surfaces with defects. The result of the training part is that a database containing a set of descriptors that typify an intact surface 31 is obtained. This database is then used in the detection process described in detail below.

The database 31 will contain groups or classes of results of the descriptive methods 35, in which each class contains a typical set of descriptors for a particular type of damage. As non-limiting examples, the database will include a set of descriptors for transverse cracks, a set for longitudinal cracks, and so on, as well as a set of descriptors for an intact paved surface.

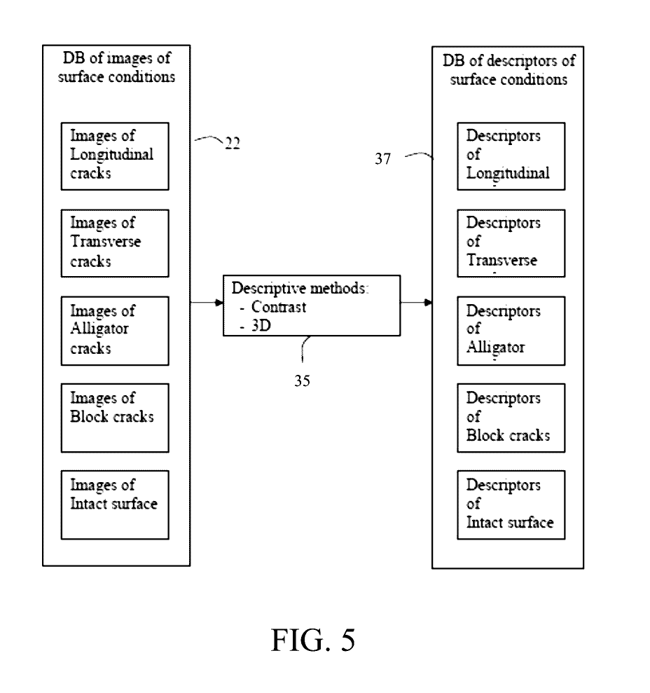

Reference is now made to FIG. 6, which illustrates schematically the detection process of the inventive method, which is separate from the training process. In the detection process, after the database of descriptors created during the training process is complete, the image processing device receives new images of surface 20 and applies to these new images the same set of descriptive methods 35 that was used in the training process. The result is a new set of descriptors 37 that are compared to the descriptors 32 that were obtained in the training process, to see if there are surface defects in the imaged surface or if the imaged surface is intact. If the descriptors 37 are similar to the descriptors of the defect-containing images defined during the training process, the image is marked as having a defect. If, in contrast, the descriptors of the image of the inspected surface are more similar to the descriptors of the training images of defect-free surfaces, then the inspected surface is marked as intact. This process can be done either in real time or offline. The class of descriptors in database 31 that most closely matches the descriptors 37 obtained in the surface images is defined as the surface condition, either an intact surface or a surface having a particular type of damage.

As a non-limiting example, in some embodiments of the method, the descriptors are obtained by measuring the contrast between pixels and their surrounding environment (“contrast descriptor” method). As another non-limiting example, in some embodiments of the invention, the detection process seeks significant height differences between pixels in the reconstructed three-dimensional image of the paved surface (“3D reconstruction descriptor”).

Contrast Descriptor Method

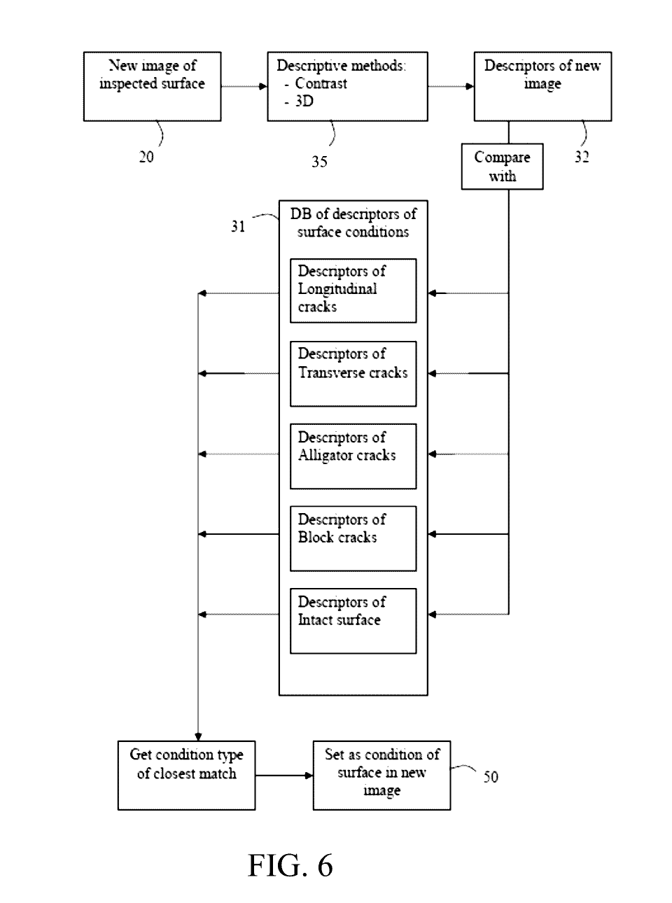

Defects in paved surfaces almost always have different illumination levels than the surrounding intact pavement. In many cases, the defects are darker than the surrounding intact surface. In other cases, the cracks are filled, e.g., by sand, and are hence brighter than the surrounding intact surface. In the contrast descriptor method, the gray level of every pixel P is determined, and each pixel is assigned a contrast value defined as the difference between its gray level and the mean gray level of the 8 nearest neighbor pixels surrounding it. Reference is now made to FIG. 7, which shows an example of a contrast descriptor method as applied to the image shown in FIG. 3 above. In order to detect large-scale damages in the paved surface, a contrast value is calculated for each pixel, but relative to the mean gray level of a larger number of neighboring pixels (as a non-limiting example, a 10×10 pixel block can be used). The size of the area used for the comparison is known as the “level,” with a higher level corresponding to a larger area. Larger-scale damage will be more apparent in higher-level comparisons than in lower-level comparisons. A number of descriptors are thereby created for each pixel in the image, according to the number of levels used.

3D Reconstruction Descriptor Method

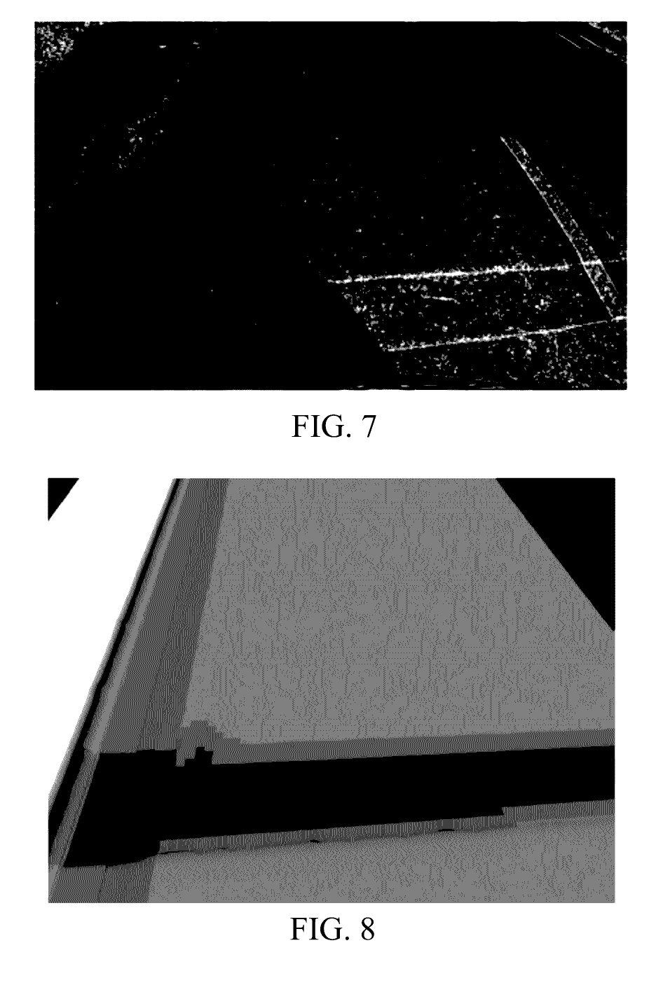

Damage to a paved surface will be deeper than the intact surface. The 3D reconstruction process provides a 3D profile of the paved surface. First, the 3D coordinates of each pixel P in the image are calculated as described above. The reconstruction process creates a voxel V for each pixel in the image. The location (x,y,z coordinates) of each voxel relative to the imaging device and the mean level of the paved surface are determined as described above. A depth value of each voxel V is calculated by obtaining the absolute difference between its depth (distance perpendicular to the road surface) with the mean surface level of the eight nearest neighbor voxels surrounding it. Voxels that are deeper than those surrounding them by more than 1 mm potentially indicate a crack in the surface. Reference is now made to FIG. 8, which presents an example of the 3D reconstruction descriptor for all of the pixels in the image shown in FIG. 3. As with the Contrast Descriptor method, larger-scale damages to the paved surface can be detected by comparing the depth of a voxel to a wider surface around it, e.g. a 10×10 voxel block, and larger-scale damage will be more apparent in higher-level comparisons than in lower-level comparisons. As with the Contrast Descriptor method, the number of descriptors created for each pixel will depend on the number of levels used.

The comparison between the descriptors 37 of the surface image and the database of descriptors 31 can be done using any method known in the art. Non-limiting examples of comparison methods that can be used include the Nearest Neighbor method (see, for example, Cover, T. M.; Hart, P. E., “Nearest Neighbor Pattern Classification,” IEEE Trans. Inf. Theory 13, 21-27 (1967), which is hereby incorporated by reference in its entirety); a Support Vector Machine (SVM) method (see, for example, Cortes, C.; Vapnik, V., “Support-Vector Networks,” Machine Learning 20, (1995), which is hereby incorporated by reference in its entirety); or a neural network method (see, for example, Siegelmann, H. T.; Sontag, E. D., “Turing Computability with Neural Nets,” Appl. Math. Lett. 4, 77-80 (1991), which is hereby incorporated by reference in its entirety). In some embodiments of the invention, the training is done manually by specifying values of descriptor results that are used as thresholds in the detection process.

In one preferred embodiment of the method, the comparison of new images to the best matching class is done by using a Nearest Neighbor method. In this method, the descriptors of pixels in the inspected image 20 are compared with the descriptors of every entry in the database for every class of surface condition. The comparison is done by determining the absolute difference between the value of each descriptor for the pixels of the inspected image and the value of the corresponding descriptor in the database. In one preferred embodiment of the method in which 3 levels are used for the descriptor method (either Contrast Descriptor or 3D Reconstruction), each pixel in the inspected image and in the database has 6 values. For each pixel in the inspected image, the absolute differences between these 6 values and the corresponding 6 values of all of the pixels in the database are determined, and the sum of the pixel-by-pixel comparisons stored. The database pixel for which the sum of the comparison values is lowest is chosen and the inspected pixel is then classified as the same class as the chosen database pixel.

As a non-limiting example, a situation can be envisaged in which there are 20 classes of surface condition in the database and 100 pixels in each class, producing a total of 2000 (20×100) pixels in the database. Each pixel in inspected image 20 is then compared with all 2000 pixels in the database, the absolute differences summed, and the sum stored. If the lowest sum of the absolute values of the differences between the values of the descriptors of the inspected image and the 2000 descriptors in the database is associated with a pixel that belongs to a class of longitudinal cracks, then the pixel of the inspected image is classified as a longitudinal crack.

As a second non-limiting example, if each descriptor method comprises four levels (8 values total) and the database comprises 20 classes of surface conditions, each class comprising 1000 pixels (20,000 total pixels in the database), then there will be 20,000 comparisons, each of which is the sum of the absolute differences between the 8 values of the descriptors from a pixel in the inspected image and the 8 values of the descriptors of the database pixel.

We claim:

1. A system for detecting and classifying defects in a paved surface, comprising:
at least one imaging device configured to be mountable on a vehicle and to obtain a sequence of images of a paved surface; and,
a processing and storage device in data communication with said at least one imaging device, said processing and storage device configured to store images obtained by said at least one imaging device and to perform three-dimensional reconstructions of overlapping portions of images obtained by said imaging device.

2. The system according to claim 1, wherein said system comprises exactly one imaging device (1), and said processing and storage device is configured to perform three-dimensional reconstructions of overlapping portions of successive images in said sequence of images.

3. The system according to claim 1, wherein said system comprises two imaging devices (1, 2) positioned such that fields of view of said imaging devices at least partially overlap, and said processing and storage device is configured to perform three-dimensional reconstructions from overlapping areas in images taken simultaneously by said two imaging devices.

4. The system according to claim 1, comprising a laser range finder.

5. The system according to claim 1, comprising a geolocation device in data communication with said at least imaging device via said storage and processing device.

6. The system according to claim 1, wherein said processing and storage device is programmed to incorporate a training process that utilizes machine learning techniques to build a database of descriptors relating to distinct features of surface conditions.

7. The system according to claim 1, wherein each of said at least one imaging device is configured to obtain images of an area of at least 4 m×4 m at a resolution of 1 mm² per pixel.

8. The system according to claim 1, wherein said at least one imaging device is mounted at the rear of a vehicle.

9. The system according to claim 6, wherein said imaging device is characterized by an image acquisition rate sufficient to provide at least 75% overlap between successive images in said image sequence.

10. A method for detecting and classifying defects in a paved surface, comprising:
obtaining a system according to claim 1;
performing a training process to build a database of descriptors of distinct features of surface conditions in images from a set of images (22) of paved surfaces with known surface conditions;
obtaining a sequence of images (20) of a paved surface;
if said system comprises exactly one imaging device, performing a three-dimensional reconstruction of overlapping areas of successive images in said sequence of images;
if said system comprises exactly two imaging devices with overlapping fields of view:
obtaining said sequence of images by obtaining a sequence of images simultaneously from each of said two imaging devices; and,
performing a three-dimensional reconstruction of overlapping areas of images obtained simultaneously by said two imaging devices; and,
performing a detection process, comprising:
calculating paved surface descriptors of said paved surface for each image in said sequence of images;
comparing said paved surface descriptors to said database of descriptors obtained from said training process;
if, in a particular image from said sequence of images, said paved surface descriptors are similar to descriptors from said database of descriptors associated with a specific defect, marking said particular image as indicating said specific defect in said paved surface;
if, in a particular image from said sequence of images, said paved surface descriptors are similar to descriptors from said database of descriptors associated with a defect-free surface, marking said particular image as indicating said paved surface is free of defects.

11. The method according to claim 10, comprising:
obtaining a system according to claim 4; and,
using said laser range finder to map a three-dimensional position of a location corresponding to each pixel in the image relative to said imaging device.

12. The method according to claim 10, comprising:
obtaining a system according to claim 5;
determining relative positions of said at least one imaging device and said geolocation device;
determining relative positions of said imaging device and a position corresponding to each pixel on said surface within said imaging device's field of view;
determining coordinates of an absolute location of said geolocation device when each image in said sequence of images is obtained; and,
calculating coordinates of an absolute location of paved surface corresponding to each pixel in said image.

13. The method according to claim 10, wherein said step of calculating paved surface descriptors comprises calculating paved surface descriptors by using a contrast method comprising:
determining a gray level for each pixel P in said image; and,
calculating a contrast value for each pixel P in said image as a sum of absolute differences between said gray level of said pixel P and an average gray level of a predetermined subset of other pixels in said image.

14. The method according to claim 13, wherein said predetermined subset comprises the eight nearest neighbor pixels surrounding pixel P.

15. The method according to claim 13, wherein said contrast method comprises calculating a plurality of contrast values for each pixel P by using a plurality of different predetermined subsets.

16. The method according to claim 10, wherein said step of calculating paved surface descriptors comprises calculating paved surface descriptors by using a 3D construction method comprising:
calculating a set of three-dimensional coordinates for each pixel P in said image, thereby creating a voxel V for each pixel P;
determining the depth of each voxel V relative to said imaging device; and,
calculating a depth value for each voxel V in said image as a sum of absolute differences between said depth of said voxel V and an average depth of a predetermined subset of other voxels in said image.

17. The method according to claim 17, wherein said 3D construction method comprises calculating a plurality of contrast values for each voxel V by using different predetermined subsets.

18. The method according to claim 10, wherein said step of comparing said paved surface descriptors to said database of descriptors obtained from said training process comprises comparing said paved surface descriptors to said database of descriptors obtained from said training process by using a Nearest Neighbor method.

19. The method according to claim 10, wherein said step of comparing said paved surface descriptors to said database of descriptors obtained from said training process comprises comparing said paved surface descriptors to said database of descriptors obtained from said training process by using a Support Vector Machine method.

20. The method according to claim 10, wherein said step of comparing said paved surface descriptors to said database of descriptors obtained from said training process comprises comparing said paved surface descriptors to said database of descriptors obtained from said training process by using a Artificial Neural Network method.
